(19) United States
(12) Patent Application Publication
(10) Pub. No.: US 2012/0156334 A1
(43) Pub. Date: Jun. 21, 2012

(54) SINGLE-USE BARREL FOR STORING AND RACKING A PRESSURIZED BEVERAGE SUCH AS BEER OR LEMONADE

(76) Inventor: Thierry Ancel, Colmar (FR)

(21) Appl. No.: 13/393,033

(22) PCT Filed: Aug. 17, 2010
(86) PCT No.: PCT/FR2010/051720

§ 371 Date: Feb. 28, 2012

(30) Foreign Application Priority Data
Aug. 28, 2009 (FR) 0955867

(51) Int. Cl. B67D 1/00; B65D 6/32; B65D 85/72; B65D 33/00; B65B 3/02; B65D 6/28; B65D 25/18

(52) U.S. Cl. 426/115; 220/4.06; 53/452

(57) ABSTRACT

The barrel includes a bag, a container and a lid that are equipped with rigid mating elements with sealing; a cap that includes a body that supports elements for closing and elements for drafting-off; a part that forms the neck, structurally separate from the lid; the outside lateral surface of the part that forms the neck and the inside lateral surface of the orifice of the lid are equipped with rigid mating elements with sealing; the bag is mated to the part that forms the neck toward its inside end; at least one hole on the container and/or the lid makes it possible to inject a positively pressurized gas inside the barrel and outside of the bag so as to compress the bag; airtight sealing elements are able to seal or open the hole, and when they seal the hole, to maintain the positive pressure that prevails inside the barrel.

The invention relates to a disposable barrel for storing and drafting off a pressurized beverage such as beer or lemon soda.

The object of the invention is more especially the barrel in question in its various possible states, in particular, on the one hand, assembled and empty of liquid, and, on the other hand, assembled and filled with liquid and ready for use. It also has as its object all of the means to be combined in a rigid manner for making up a thus assembled barrel. It finally has as its object the process for packaging a liquid such as a pressurized beverage in such a barrel.

The document WO 2008/132328 describes a barrel that first of all comprises an airtight and flexible plastic bag that can contain the liquid and that can withstand the internal or external pressure exerted on it, and that is equipped with an opening through which it is possible to ensure respectively its filling with the liquid or the drafting off of the liquid that it contains.

The barrel according to the document WO 2008/132328 next comprises a container that can accommodate the bag, of a shape that can make up an inside volume on the order of 5, 10 or 15 liters that is adapted to the capacity of the bag and that can make it possible to interlock the container with other analogous containers before their assembly for the purpose of making up barrels, with the container having a rigidity that can withstand the pressure that prevails in the barrel once assembled, and finally comprising an opening that is suitable for filling the bag.

The barrel according to the document WO 2008/132328 next comprises a lid in the general shape of a cap, able to close the container on the side of its opening, having a rigidity that can withstand the pressure that prevails in the barrel once assembled, comprising, on one side, an opening, and, on the opposite side, an orifice that is equipped at the factory with a neck that is an integral part of the lid, which neck, cylindrical in shape, extends toward the outside of the lid and the barrel.

The container and the lid, equipped with complementary rigid mating means, with sealing, can be forced together rigidly by crimping, with sealing, their two openings, which then are mated.

The bag can be combined in a rigid and airtight way with the lid, with its opening then being arranged opposite the neck and in communication with it.

Finally, the barrel according to the document WO 2008/132328 comprises a cap that comprises a hollow cylindrical lateral body that supports means for closing the barrel and means for drafting off the liquid.

The inside lateral surface of the neck of the lid and the mated outside lateral surface of the body of the cap, equipped with complementary rigid mating means, with sealing, can be mated rigidly, with sealing.

The teaching of the document WO 2008/132328, useful as it may be relative to certain design principles of a barrel for storing and drafting off a pressurized beverage (beer, lemon soda), does not make it possible to envision or to ensure production that is at the same time easy, economical, effective and industrializable. Actually, the barrel that is considered here is typically a domestic, disposable barrel that can be manufactured in large quantities in a reliable way and under acceptable cost conditions relative to the destination of such a barrel. In addition, it is important that such a barrel provide a full extended guarantee in terms of safety, in particular that the user cannot improperly reuse the barrel or open it.

The document U.S. Pat. No. 5,267,669 describes a beverage distributor that comprises a flexible bag whose peripheral opening edge is clamped in a slot of the body of the distributor or, preferably, is placed in such a way as to be held by two mating parts of the body of the distributor. In the upper part, the distributor comprises an orifice that is tapped in communication with the inside of the bag, to which can be attached, on the outside, drafting-off means. Thus, the peripheral edge of the bag is itself removed from the orifice that is tapped and drafting-off means. Such a design cannot provide the guarantee of a hold that is both airtight and pressure-resistant, apart from the fact that the installation of the bag is complex.

The document DE-U-9218003 describes a structure that is close to the preceding one with the same drawbacks.

In the field of still beverages, and more particularly that of wine, the design of “bag-in-a-box” (see, for example, GB-A-2 419 870) has been developed. A bag-in-a-box consists of a plastic bag that is filled with liquid, housed in a corrugated cardboard outer packaging with a spout. However, such a bag-in-a-box proves unsuitable to the packaging of pressurized beverages. Actually, the bag can expand until the outer packaging becomes deformed.

The object of the invention is to remedy the above-mentioned drawbacks by proposing a disposable, in particular domestic, barrel, for storing and drafting off a pressurized beverage (beer, lemon soda) of the general type that is described in the document WO 2008/132328, but that, because of its structure, made it possible to consider an embodiment that is at the same time easy, economical, effective and industrializable, suitable for a domestic, disposable barrel that provides its full guarantee in terms of safety, in particular for reusing or opening the barrel.

For this purpose, and according to a first aspect, the object of the invention is a barrel in the assembled state and empty of liquid, especially suitable for storing and drafting off a liquid such as a pressurized beverage, comprising:
An airtight and flexible bag, able to contain liquid and to withstand the internal or external pressure exerted on it, and equipped with an opening through which it is possible to ensure respectively its filling with the liquid or the drafting off of the liquid that it contains;
A container that accommodates the bag, having a rigidity that can withstand the pressure that exists inside the barrel and comprising an opening that is suitable for filling the bag; and a lid in the general shape of a cap, closing the container on the side of its opening, having a rigidity that can withstand the pressure that exists inside the barrel, comprising, on one side, an opening, and having, in a terminal wall of the opposite side, an orifice opposite the opening of the bag and in communication with it; the container and the lid equipped with complementary rigid mating means with sealing being mated rigidly with sealing, with their two openings being mated; a neck that is generally cylindrical in shape extending toward the outside of the lid and the barrel and located opposite the orifice of the lid and in communication with it;
A cap that comprises a hollow cylindrical lateral body that supports means for closing the barrel and means for drafting off the liquid, with the inside lateral surface of the neck and the mated outside lateral surface of the body of the cap equipped with complementary rigid mating means with sealing being mated rigidly with sealing;
   characterized in that:
The neck is a part that is structurally separate from the lid;
The outside lateral surface of the part that forms the neck and the mated inside lateral surface of the orifice of the lid are equipped with complementary rigid mating means with sealing, the part forming the neck and the lid being mated rigidly with sealing, the part that forms the neck passing through the lid and its inside end being located inside the lid;
The bag is combined in a rigid and airtight way with the part that forms the neck toward its inside end;
At least one hole, made on the container and/or the lid, can make it possible to inject a positively pressurized gas inside the barrel and outside of the bag so as to compress the bag;
Airtight sealing means that can be maneuvered outside of the barrel are able, in a selective way, to seal tightly or to open the hole and, when they seal the hole, to maintain the positive pressure that prevails inside the barrel, with the sealing means and the container and/or the lid where the hole is made being equipped with complementary rigid mating means.

According to one embodiment, the complementary rigid mating means of the part that forms the neck and the lid ensure an irreversible rigid mating, with the part forming the neck and the lid being mated rigidly and irreversibly.

According to one embodiment, the complementary rigid mating means of the part that forms the neck and the lid comprise mated surfaces that are held rigidly together by contact and forced interlocking.

According to one embodiment, the orifice of the lid is limited laterally by a flange (16) that is generally cylindrical in shape, extending projecting from the terminal wall of the lid toward the outside of the latter, and whose inside lateral surface of which flange is equipped with rigid means for mating with the part that forms the neck.

According to one embodiment, the terminal wall of the lid comprises a groove that extends toward the inside of the lid.

According to one embodiment, the part that forms the neck, structurally separate from the lid, comprises, on the one hand, a lateral wall that is generally cylindrical in shape whose outside lateral surface is equipped with rigid means for mating with the lid and whose inside lateral surface is equipped with rigid means for mating with the cap, and, on the other hand, an inside end wall in the shape of a disk that just abuts against the inside surface of the terminal wall of the lid and with which the bag is mated in a rigid and airtight way by the edge of its opening.

According to one embodiment, the part that forms the neck, structurally separate from the lid, comprises a lateral wall that is generally cylindrical in shape and an inside end wall that is generally in the shape of a disk, with which the edge of the opening of the bag is mated in a rigid and airtight way by welding or gluing.

According to one embodiment, the complementary rigid mating means of the part that forms the neck and the cap comprise mated surfaces that are held rigidly together by contact and forced interlocking.

According to one embodiment, the body of the cap is terminated by an outside end part, projecting laterally, and in the shape of a disk just abutting against an outside end part, projecting laterally, and in the shape of a disk of the lateral wall of the part that forms the neck.

According to one embodiment, the at least one hole is made on the lid, and, more specially, on the terminal wall of the lid in the vicinity of its orifice.

According to one embodiment, the at least one hole is limited by an end fitting that extends toward the outside, suitable for mounting a pipe for injecting a positively pressurized gas.

According to one embodiment, the means for airtight sealing of the hole is a part made of deformable plastic material, able to be deformed when it is subjected to a force that corresponds to a known pressure that is exerted on it, maneuvered for deformation of the outside of the barrel in response to the injection, inside the barrel, of the positively pressurized gas through the at least one hole, whereby said part of the sealing means, on the one hand, opens the hole when the positively pressurized gas is injected inside the barrel, and, on the other hand, seals the hole when the injection of the positively pressurized gas inside the barrel is halted or the inside of the barrel is positively pressurized.

In this embodiment and according to a possible implementation, the deformable part of the means for airtight sealing of the hole comprises a deformable part that forms a valve that is located against the inside surface of the wall where the at least one hole is located, opposite this at least one hole.

In this same embodiment and according to a possible implementation, the complementary rigid mating means of the deformable part of the sealing means and the wall where the at least one hold is located comprise at least one projection-recess unit that is rigidly held together by contact and forced interlocking.

According to one embodiment, the complementary rigid mating means of the container and the lid ensure an irreversible rigid mating, with the lid and the container being mated rigidly and irreversibly.

According to one embodiment, the container, on one hand, and the lid, on the other hand, comprise, on one hand, a lateral wall that limits its opening, extending axially, that is generally cylindrical or prismatic in shape and slightly tapered toward the opening, and on the other hand, a terminal wall that extends in a transverse plane.

According to one embodiment, the container and/or the lid comprises stiffening reliefs.

According to one embodiment, the container and the lid have an axial dimension that is analogous or of the same order of magnitude. According to another embodiment, the lid has a given axial dimension, whereas the container can have one of several given axial dimensions, based on the capacity of the bag.

According to one embodiment, the container, the lid, the bag and the part forming the neck are made of plastic material.

According to the embodiments, the bag has a capacity of between on the order of 5 liters to 15 liters. As indicated, it is possible to provide that when the bag has a capacity in the range being considered and is therefore sized accordingly, all of the constituent parts of the barrel have constant given dimensions except for the reservoir that can have an axial dimension that is more or less large depending on whether the bag has a more or less large capacity.

According to one embodiment, the barrel in the assembled state and empty of liquid is such that with the unit that consists of the bag-part that forms the neck being produced, the bag that has been attached to the part that forms the neck but is not yet filled with liquid, this unit is sealed by means of a removable stoppering system such as a removable protective cap, so as to keep the bag sterile until the time it is filled with liquid. This structural arrangement makes it possible to manufacture the constituent elements at different locations and to assemble them at another.

According to a second aspect, the object of the invention is a barrel in the assembled state and filled with liquid, ready for use, comprising a barrel as it was just described, the bag being filled with a liquid such as a pressurized beverage, a positively pressurized gas that is inside the barrel and outside of the bag so as to compress the bag that is filled with liquid.

According to one embodiment in the case where the barrel in the assembled state and empty of liquid comprises a removable stoppering system of the bag, this removable stoppering system of the unit that consists of the bag-part that forms the neck is removed before the bag is filled with liquid.

According to a third aspect, the object of the invention is a set of means to mate in a rigid way for making up a barrel as just described, comprising:
An airtight and flexible bag, able to contain liquid and to withstand the internal or external pressure that can be exerted on it, equipped with an opening through which it is possible to ensure respectively its filling with the liquid or the drafting off of the liquid that it contains;
A container that can accommodate the bag, having a rigidity that can withstand the pressure that can exist inside the barrel, and comprising an opening that is suitable for filling the bag; and a lid in the general shape of a cap, able to close the container from the side of its opening, having a rigidity that can withstand the pressure that may exist inside the barrel, comprising, on one side, an opening, and having, in a terminal wall of the opposite side, an orifice that can be opposite the opening of the bag and in communication with it; with the container and the lid equipped with complementary rigid mating means with sealing being able to be mated rigidly with sealing, and their two openings being mated;
A part that forms the neck, structurally separate from the lid, generally cylindrical in shape, with the outside lateral surface of the part that forms the neck and the mated inside lateral surface of the orifice of the lid being equipped with complementary rigid mating means with sealing, the part that forms the neck and the lid being able to be mated rigidly with sealing, the part that forms the neck being able to pass through the lid, its inside end being able to be located inside the lid, with the part that forms the neck being able to extend toward the outside of the lid and the barrel and to be located opposite the orifice of the lid and in communication with it, with the bag being able to be mated in a rigid and airtight way to the part that forms the neck toward its inside end;
A cap that comprises a hollow cylindrical lateral body that supports means for closing the barrel and means for drafting off liquid, with the inside lateral surface of the part that forms the neck and the mated outside lateral surface of the body of the cap equipped with complementary rigid mating means with sealing being able to be mated rigidly with sealing;
At least one hole, made on the container and/or the lid, able to make it possible to inject a positively pressurized gas inside the barrel and outside of the bag so as to compress the bag;
Airtight sealing means, able, in a selective way, to seal tightly or to open the hole and, when they seal the hole to maintain the positive pressure that prevails inside the barrel, the sealing means and the container and/or the lid where the hole is made being equipped with complementary rigid mating means.

According to one embodiment, the unit also comprises a removable stoppering system such as a removable protective cap that is designed to seal the unit that consists of the bag-part that forms the neck after the bag has been attached to the part that forms the neck but before the bag is filled with liquid.

According to a fourth aspect, the object of the invention is a process for packaging a liquid, such as a pressurized beverage in a barrel that is specially suitable for storing and for drafting off this liquid, as just described, in which:
The set of means as just described is used, with the bag being empty of liquid, and the liquid to be packaged is used;
The bag that is empty of liquid is mated in a rigid and airtight way to the part that forms the neck;
The part that forms the neck—to which the bag is mated in a rigid way—is mated in a rigid and airtight way to the lid, with the bag being placed inside the lid; and the bag is placed inside the container;
Then, the container and the lid are mated in a rigid and airtight way;
Then, the bag is filled with the liquid by the part that forms the neck and the opening of the bag;
Then, the cap is mated in a rigid and airtight way to the part that forms the neck.

According to one embodiment, once the container and the lid are mated in a rigid and airtight way and the bag is filled with liquid, a positively pressurized gas is injected inside the barrel and outside of the bag so as to compress the bag that is filled with liquid, with the means for sealing the hole sealing the latter.

According to one embodiment in which the barrel in the assembled state and empty of liquid comprises a removable stoppering system, once the unit that consists of the bag-part that forms the neck is made—with the bag having been attached to the part that forms the neck but not yet filled with liquid—this unit is sealed by means of a removable stoppering system so as to keep the bag sterile, and, before the bag is filled with liquid, the stoppering system is removed.

The invention will now be described using drawings (which are not on the same scale), in which:

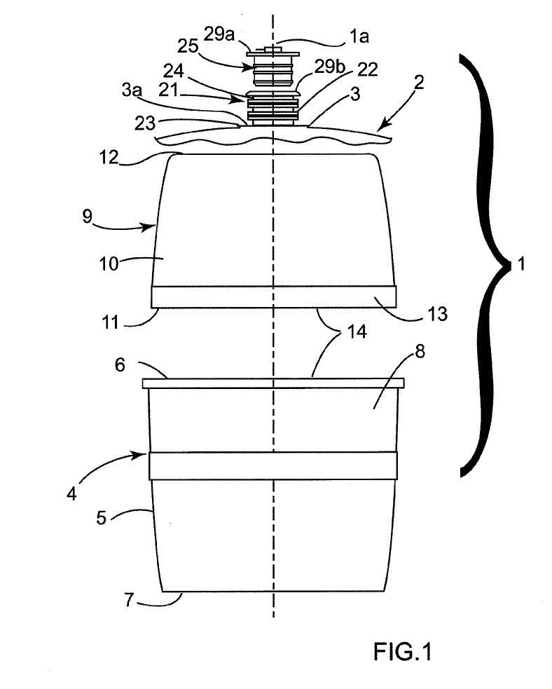

FIG. 1 is an elevation view of a barrel according to the invention, in the non-fully-assembled state, with the bag being shown only partially and symbolically,

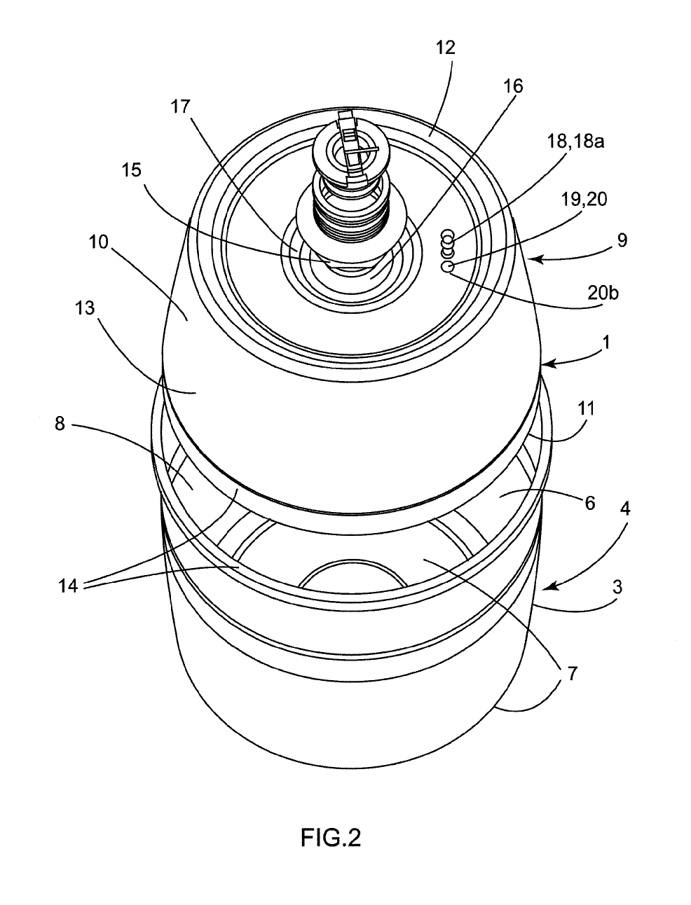

FIG. 2 is a top perspective view of the barrel that is shown in FIG. 1, with the bag not being shown,

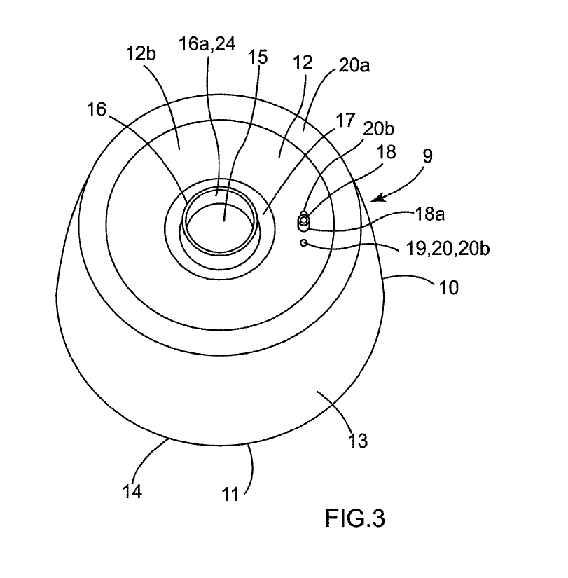

FIG. 3 is a top perspective view of the lid of the barrel, with the sealing means being removed,

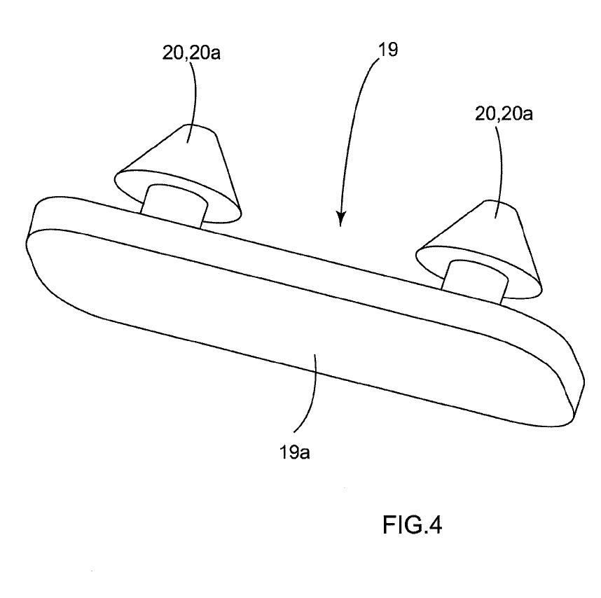

FIG. 4 is a perspective view of a part that forms the means for airtight sealing of the hole for injecting positively pressurized gas inside the barrel and outside of the bag,

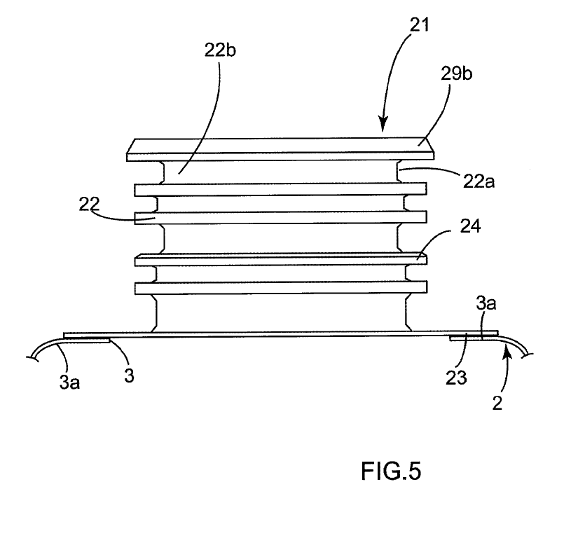

FIG. 5 is an elevation view of the part that forms the neck of the barrel,

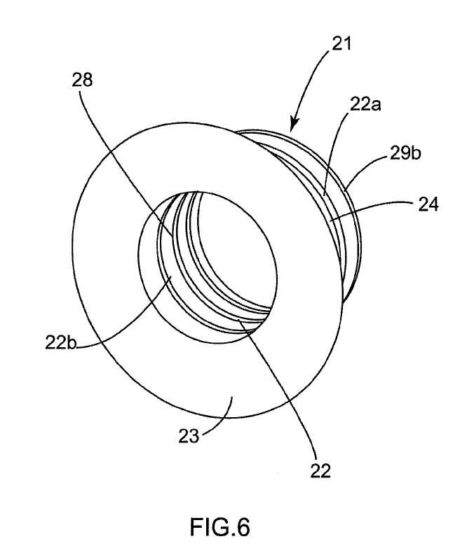

FIG. 6 is a perspective view of the inside of the part that forms the neck of the barrel,

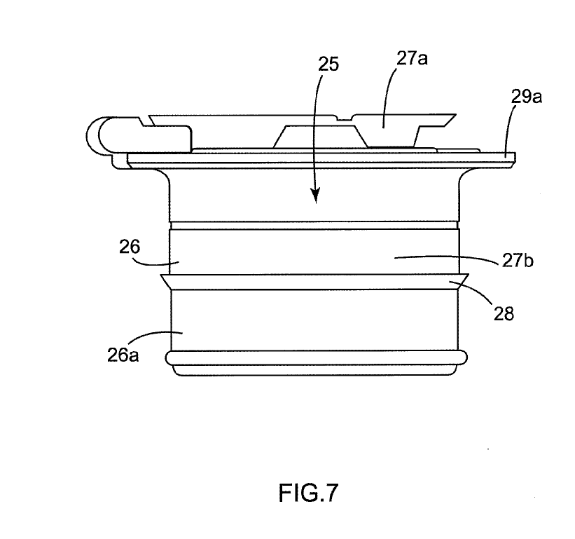

FIG. 7 is an elevation view of the cap of the barrel,

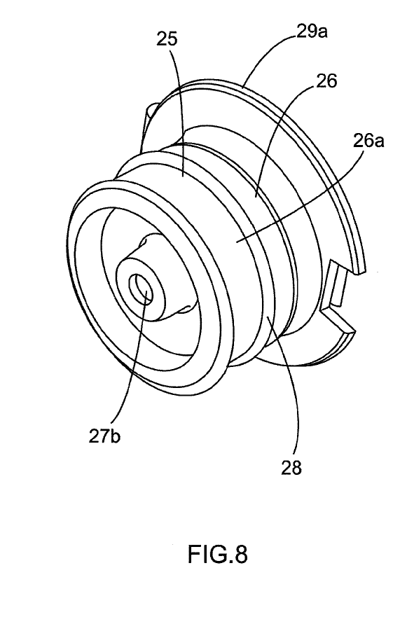

FIG. 8 is a perspective view from the inside of the cap of the barrel.

The disposable barrel 1 according to the invention, for domestic use in particular, is specially designed for storing and drafting off a pressurized beverage such as beer or lemon soda.

The object of the invention is the barrel 1 in its different possible states, in particular the assembled state and empty of liquid, and the assembled state and filled with liquid and ready for use. It also has as its object all of the means to be mated in a rigid way for making up such a barrel 1. Finally, it has as its object the process for packaging a liquid such as a pressurized beverage in such a barrel 1.

Such a barrel 1 rests on the teaching of the document WO 2008/132328, accessible to one skilled in the art, while having a structure that makes it possible to envision an easy, economical, effective and industrializable embodiment that is suitable for a domestic, disposable barrel 1 and that provides a full extended guarantee in terms of safety, in particular for reuse or for opening the barrel 1.

The barrel 1 is made from a set of means (or parts) that are rigidly mated. Once rigidly mated, these parts form the barrel 1 that has a general axis of symmetry 1a.

The word “axial” is to be defined relative to the axis 1a. The word “transverse” is to be defined as meaning perpendicular, orthogonal, essentially perpendicular or essentially orthogonal to the axis 1a.

In its position of use, the barrel 1 is placed with the vertical or essentially vertical axis 1a.

The barrel 1 first comprises an airtight and flexible bag 2 that can contain liquid and withstand the internal or external pressure that can be exerted on it. The bag 2 is equipped with an opening 3 that has an edge 3a, an opening 3 through which it is possible to ensure respectively its filling with liquid or the drafting off of liquid that it contains.

The bag 2 consists of, for example, either two analogous sheets that are generally rectangular or pseudo-rectangular in shape, placed opposite and welded to one another at the location or close to their lateral edges except for the opening 3 or a sheath section that is closed at one end and whose other open end forms the opening 3.

The plastic material that constitutes the bag 2 is selected so as to be compatible with the liquid to be stored. It is also selected so that the bag 2 is flexible enough, pressure-resistant, and airtight. For example, it is selected to have a selective sealing: airtight from the inside to the outside to carbon dioxide and permeable to oxygen to a certain extent from the outside to the inside.

For the application of the barrel 1 that is envisioned, the bag 2 has a capacity that can be between on the order of 5 liters to 15 liters.

Secondly, the barrel 1 comprises a container 4 that can accommodate the bag 2.

The container 4 has a rigidity that can withstand the pressure that can exist inside the barrel 1.

The container 4 comprises a lateral wall 5 that limits, on the one side, an opening 6. This lateral wall 5 extends axially and, in the embodiment shown, it is generally cylindrical in shape, slightly tapered toward the opening 6.

“Cylindrical” is defined as an effectively cylindrical shape or a pseudo-cylindrical or prismatic or pseudo-prismatic shape.

The container 4 also comprises, from the side opposite to the opening 6, a terminal wall 7, extending at least essentially in a transverse plane.

Such a container 4 defines an inside cavity 8.

Thirdly, the barrel 1 comprises a lid 9 that can close the container 4 from the side of its opening 6.

The lid 9 has a rigidity that can withstand the pressure that can exist inside the barrel 1.

The lid 9 comprises a lateral wall 10 that limits an opening 11 from one side. This lateral wall 10 extends axially, and, in the embodiment shown, it is generally cylindrical in shape, slightly tapered toward the opening 11.

The lid 9 also comprises, from the side opposite to the opening 11, a terminal wall 12, extending at least essentially in a transverse plane.

Thus, the lid 9 is generally in the shape of a cap that is more or less flattened or, in contrast, more less hollow, according to the embodiments.

Such a lid 9 defines an inside cavity 13.

The word “inside” is to be understood as being in or toward the cavity 8 or the cavity 13 or the cavity that is formed by the two cavities 8 and 13.

The container 4 and the lid 9 are, in the embodiment that is being considered, made of plastic. If necessary, they comprise stiffening reliefs.

In the embodiment that is shown in the drawings, the container 4 and the lid 9 have an axial dimension that is analogous or of the same order of magnitude. In other embodiments, the axial dimension of the container 4 is larger than that of the lid 9, and the latter can have the shape of a flattened cap. In contrast, it is possible to provide that the lid 9 has a given axial dimension, whereas the container 4 can have one of several given axial dimensions, based on the capacity of the bag 2. Thus, whereas the bag 2 can have a capacity in the range indicated above, as necessary, the lid 9 and the other constituent parts of the barrel 1 have constant given dimensions, except for the reservoir 4 that has a more or less large axial dimension according to whether the bag 2 has a more or less large capacity. This structural arrangement makes it possible to streamline the manufacturing of barrels while ensuring their diversity of capacity.

The slightly tapered form of the container 4 and the lid 9, toward the openings 6 and 11, respectively, makes it possible to stack containers 4 and lids 9 before their assembly. The containers 4 or the lids 9 that are thus stacked can be easily shipped, so it is not problematic for the manufacturing site to be some distance from the assembly site.

The openings 6 and 11 have analogous dimensions in such a way as to be able to be placed in mated fashion, with the container 4 and the lid 9 of a barrel 1 being head-to-foot. The dimensions of the container 4 and the lid 9 are determined in such a way that once mated, they form an inside cavity 8+13 of a shape and volume adapted to the shape and the capacity of the bag 2.

Toward the openings 6 and 11, the container 4 and the lid 9 are equipped with complementary rigid mating means 14 with sealing. These means can be mated rigidly with sealing, with the openings 6 and 11 being mated. According to the envisioned embodiment, the rigid mating means 14 ensure an irreversible rigid mating, in such a way that the container 4 and lid 9 are, once the barrel 1 is produced, mated rigidly and irreversibly.

In its terminal wall 12, the lid 9 comprises an orifice 15.

The orifice 15 can be opposite the opening 3 of the bag 2 and in communication with it.

The orifice 15 is limited laterally by a flange 16 that is generally cylindrical in shape, extending axially projecting from the terminal wall 12 of the lid 9, toward the outside of the latter.

In contrast, according to the embodiment that is shown, the terminal wall 12 of the lid 9 comprises a peripheral groove 17 that extends toward the inside of the lid 9 and therefore is open toward the outside of the latter.

In the embodiment shown, a hole 18 is provided, made on the terminal wall 12 of the lid 9 in the vicinity of the orifice 15.

This hole 18 is limited by an end fitting 18a, extending toward the outside, capable of mounting a pipe for injection of positively pressurized gas. The hole 18 and its end fitting 18a form a sort of nipple.

The hole 18 is designed to inject a positively pressurized gas inside the barrel 1, i.e., into the cavity 8+13, but outside of the bag 2, so as to compress the bag 2 and the liquid that it contains.

It is understood that according to other variants, not a single hole 18, but rather several holes 18 can be provided. Such a hole 18 can be provided not on the terminal wall 12 of the lid 9, but on its lateral wall 10. There may also be provided a hole 18 that is not on the lid 9 but rather on the container 4, or else—in the case of several holes 18—on the lid 9 and the container 4.

In the embodiment shown, the flange 16, the end fitting 18a, and the sealing means 20 are all housed back from a plane that is formed by the outside surface of an annular peripheral edge 12a of the terminal wall 12, limiting a recessed part 12b of this wall, toward the center of which the groove 17 is located. With this structure, it is possible to have a flange 16 that has an adequate axial dimension for an effective irreversible rigid hold, without the flange 16 projecting from said plane, which would be a problem for stacking lids 9 before assembly and the preservation of the integrity of the flange 16. This structure also makes it possible to stack assembled barrels on one another.

Fourthly, the barrel 1 comprises airtight sealing means 19, able to be maneuvered outside of the barrel and able, in a selective way, to seal tightly or, in contrast, to open the hole 18.

These means 19 are also able, when they seal the hole 18, to maintain the positive pressure that prevails inside the barrel 2 as in the case of a non-return valve.

Of course, the number and the arrangement of the means 19 are adapted to the number and the arrangement of the hole(s) 18.

According to the embodiment that is shown, the means 19 are a part 19a that is made of deformable plastic, able to be deformed when it is subjected to a force that corresponds to a known pressure that is exerted on it. By so doing, the part 19a can be maneuvered in such a way as to be deformed from the very outside of the barrel 1, in response to the injection, inside the barrel 1, of the positively pressurized gas through the hole 18 that is provided for this purpose.

The part 19a opens the hole 18 when the positively pressurized gas is injected inside the barrel 1 via the hole 18. Conversely, the part 19a seals the hole 18 when the injection of positively pressurized gas inside the barrel 1 is halted or when the inside of the barrel 1 is positively pressurized.

The part 19a comprises a deformable part that forms a valve that is designed to be located against the inside surface of the terminal wall 12 of the lid 9, where the hole 18 is located, by being opposite this hole 18.

It is also provided that, on the one hand, the means 19, and, on the other hand, in this case the lid 9—and more specially its terminal wall 12 where the hole 18 is made—are equipped with complementary rigid mating means 20.

Such rigid mating means 20 can comprise, in the embodiment shown, two units that each comprise a projection 20a and a complementary recess 20b, one—for example the projection 20a—being made on the part 19a and the other—the recess 20b, formed by a hole—being made on the terminal wall 12 of the lid 9.

These two units that consist of projection 20a-recess 20b are located on either side of the hole 18 and close to it.

Of course, three, four . . . units that consist of projection 20a-recess 20b or else a unit that is extended linearly surrounding a hole 18 can be provided.

Thus, using rigid mating means 20, the means 19 are held rigidly together in the lid 9 by contact and forced interlocking.

The structure that has just been described is suitable in the case where it is provided.

It is understood that according to other variants, several holes 18 or one or more holes 18 can be provided on the lateral wall 10 of the lid 9 or on the container 4 or on the lid 9 and the container 4.

Fifthly, the barrel 1 comprises a part that forms the neck 21, axially hollow on either side, by making up a passage that is generally cylindrical in shape. This part 21 is made of plastic.

The part 21 that forms the neck is structurally separate from the lid 9. It is thereby necessary to understand that this is a part that is separate from the lid 9.

The part 21 that forms the neck comprises a lateral wall 22 and an inside end wall 23 that is in the shape of a disk to which the edge 3a of the opening 3 of the bag 2 is mated in a rigid and airtight way by welding or gluing.

The outside lateral surface 22a of the lateral wall 22 of the part 21 that forms the neck and the mated inside lateral surface 16a of the flange 16 that limits the orifice 15 of the lid 9 are equipped with complementary rigid mating means 24 with sealing.

Thus, the part 21 that forms the neck and the lid 9 can be mated rigidly with sealing.

In this situation, the part 21 that forms the neck extends toward the outside of the lid 9 and the barrel 1 and is located opposite the orifice 15 of the lid 9 and in communication with it by the axial recess that constitutes a passage that it forms. The part 21 that forms the neck passes through, on the other hand, the lid 9 by the orifice 15. Finally, its inside end—namely the inside end wall 23—is located inside the lid 9, abutted against the inside surface of the terminal wall 12.

The complementary rigid mating means 24 of the part 21 that forms the neck and the lid 9 ensure an irreversible rigid mating, in such a way that the part 21 that forms the neck and the lid 9 are mated rigidly and irreversibly. For example, the means 24 comprise mated surfaces that are held rigidly together by contact and forced interlocking.

Sixthly, the barrel 1 comprises a cap 25.

The cap 25 comprises a hollow cylindrical lateral body 26 that supports means 27a for closing the barrel and means 27b for drafting off the liquid. Such means 27a, 27b can be the object of various embodiments, in particular the one that is described in the document WO 2008/132328.

The internal lateral surface 22b of the part 21 that forms the neck and the mated outside lateral surface 26a of the body 26 of the cap 25 are equipped with complementary rigid mating means 28 with sealing.

Thus, the part 21 that forms the neck and the cap 25 can be rigidly mated with sealing.

The complementary rigid mating means 28 of the part 21 that forms the neck and the cap 25 ensure an irreversible rigid mating, in such a way that the part 21 that forms the neck and the cap 25 are mated rigidly and irreversibly. For example, the means 28 comprise mated surfaces that are held rigidly together by contact and forced interlocking.

In this situation, an outside end part 29a, projecting laterally and in the shape of a disk, of the body 26 of the cap 25 can just abut against an outside end part 29b, projecting laterally and in the shape of a disk of the lateral wall 22 of the part 21 that forms the neck. In this situation, the outside end part 29b has an end-of-travel stop function.

The part 29b furthermore tends to be tapered after interlocking in such a way as to ensure an irreversible assembly.

The outside end part 29b can have another function whereas the bag 2 has been attached to the part 21 that forms the neck, but it is not yet filled with liquid. Actually, it is possible, once the unit that consists of the bag 2—part 21 that forms the neck is produced, to seal this unit by means of, sixthly, a removable protective cap or another removable stoppering system, so as to keep the bag sterile until the time when it is filled with liquid.

This structural arrangement makes it possible to prepare, in a manufacturing site, the unit that consists of the bag 2—part 21 that forms the neck and then to ship it without risk of contamination to another site for the purpose of completing the assembly of the barrel 1 and its filling.

Thus, the barrel 1 in the assembled state and empty of liquid comprises:
The bag 2;
The container 4 and the lid 9 that closes the container 4 and is equipped with the flange 16, mated rigidly, irreversibly and with sealing, and forming an 8+13 cavity in which the bag 2 is located;
The part 21 that forms the neck that is structurally separate from the lid 9 and mated to it rigidly, irreversibly and with sealing by being housed in the orifice 15, and to which the bag 2 is mated rigidly and with sealing;
The cap 25 that comprises the means 27a for closing the barrel 1 and the means 27b for drafting off the liquid, mated to the part 21 that forms the neck rigidly, irreversibly and with sealing by being housed in it;
At least one hole 18, made on the container 4 and/or the lid 9 for injecting a positively pressurized gas inside the barrel 1 and outside of the bag 2 so as to compress the bag 2 that is filled with liquid;
And sealing means 19 that can, in a selective way, seal tightly or open the at least one hole 18, and, when they seal the at least one hole 18, to maintain the positive pressure that prevails inside the barrel 1,
And, if necessary, the above-mentioned removable stoppering system.

As indicated, in this state, the barrels 1 can be filled.

A rigid, irreversible and airtight mating of two constituent parts of the barrel 1 can be implemented in a manner that is functionally analogous to a forced crimp, with the invention also including other ways of doing so. For example, it is possible to provide first putting the two parts into their suitable relative positions and then to tightly, irreversibly and rigidly mate them by welding.

The irreversibility of the rigid mating of two parts is understood to occur when detachment forces that would be normal for any user are exerted on these two parts or because, if an attempt were made to detach them, the two parts would be degraded enough to prevent the barrel from being reused.

It is possible to provide related sealing means for insertion between two parts.

The sealing in question is obviously not absolute but is defined by a sealing that is at least just enough relative to the domestic use of the barrel 1. According to the fluids involved, this sealing is a sealing against liquids or gases.

In another state, the barrel 1 is assembled and filled with liquid, ready for use. In this case, the bag 2 is filled with the liquid being considered, such as a pressurized beverage, while a positively pressurized gas is inside the barrel 1 and outside of the bag 2 so as to compress the bag 2 that is filled with liquid.

In this situation, the barrel 1 can be used for the purpose of drafting off liquid with the cap 25 in the lowest position, with the terminal wall 7 being in the highest position. The opening of the cap 25 with the drafting-off means 27b is in a lower position and directed downward. However, using sealing means 19, it is possible to draft off the liquid, by avoiding any suction phenomenon. This drafting-off is possible, without the necessity for adding pressurized gas, by simple gravity.

In one embodiment in which the barrel 1 in the assembled state and empty of liquid comprises a removable stoppering system, this removable stoppering system of the unit that consists of the bag 2—part 21 that forms the neck is removed before the bag 2 has filled with liquid.

The process for packaging a liquid such as a pressurized beverage in a barrel 1 that is specially suitable for storing and drafting off this liquid, as it has been described, is as follows.

The set of constituent means of the barrel 1, described above, with the bag 2 being empty of liquid, is used.

The liquid to be packaged is also used.

The bag 2, empty of liquid, is mated in a rigid and airtight way to the part 21 that forms the neck.

Furthermore, the part 21 that forms the neck—to which the empty bag 2 is then mated in a rigid way—is mated in a rigid, irreversible and airtight way to the lid 9, with the bag 2 being placed inside the lid 9. This operation is carried out by stacking the part 21 that forms the neck in the orifice 15 of the lid, from the inside cavity 13 of the latter, and a forced interlocking is initiated. In contrast, the bag 2 is placed inside the container 4.

Then, the container 4 and the lid 9 are mated in a rigid, irreversible and airtight way, with the bag 2 thus being housed in the cavities 8 and 13. This operation is implemented by a forced interlocking.

Then, the bag 2 is filled with the liquid by the part 21 that forms the neck and the opening 3 of the bag 2.

Then, the cap 25 is mated in a rigid, irreversible and airtight way to the part 21 that forms the neck. This operation is implemented from the outside of the barrel 1, by initiating a forced interlocking.

In contrast, once the container 4 and the lid 9 are mated in a rigid, irreversible and airtight way and the bag 2 is filled with liquid, a positively pressurized gas is injected inside the barrel 1, into the cavity 8+13, and outside of the bag 2, via the at least one hole 18, so as to compress the bag 2 that is filled with liquid, with the means 19 for sealing at least one hole 18 sealing the latter.

In the case of a barrel 1 in the assembled state and empty of liquid comprising a removable stoppering system, once the unit that consists of the bag 2—part 21 that forms the neck is produced—with the bag 2 having been attached to the part 21 that forms the neck but is not yet filled with liquid—this unit 2+21 is sealed by means of a removable stoppering system so as to keep the bag (2) sterile, and thereby before the bag 2 is filled with liquid, the stoppering system is removed.

As has been defined, the constituent parts of the barrels can be manufactured on certain sites, be easily shipped, and then be assembled on other sites.

1. Barrel (1) in the assembled state and empty of liquid, especially suitable for storing and drafting off a liquid such as a pressurized beverage, comprising:
An airtight and flexible bag (2), able to contain liquid and to withstand the internal or external pressure exerted on it, equipped with an opening (3) through which it is possible to ensure respectively its filling with the liquid or the drafting off of the liquid that it contains;
A container (4) that accommodates the bag (2), having a rigidity that can withstand the pressure that exists inside the barrel and comprising an opening (6) that is suitable for filling the bag (2); and a lid (9) in the general shape of a cap, closing the container (4) on the side of its opening (6), having a rigidity that can withstand the pressure that exists inside the barrel (1), comprising, on one side, an opening (11), and having, in a terminal wall (12) of the opposite side, an orifice (15) opposite the opening (3) of the bag (2) and in communication with it; with the container (4) and the lid (9) equipped with complementary rigid mating means (14) with sealing being mated rigidly with sealing, with their two openings (6, 11) being mated; a neck that is generally cylindrical in shape extending toward the outside of the lid (9) and the barrel (1) and located opposite the orifice (15) of the lid (9) and in communication with it;
A cap (25) that comprises a hollow cylindrical lateral body (26) that supports means (27a) for closing the barrel and means (27b) for drafting off the liquid, with the inside lateral surface (22b) of the neck and the mated outside lateral surface (26a) of the body (26) of the cap (25) equipped with complementary rigid mating means (28) with sealing being mated rigidly with sealing;
characterized in that
The neck is a part (21) that is structurally separate from the lid (9);
The outside lateral surface (22a) of the part (21) that forms the neck and the mated inside lateral surface (16a) of the orifice of the lid (9) are equipped with complementary rigid mating means (24) with sealing, with the part (21) that forms the neck and the lid (9) being mated rigidly with sealing, the part (21) that forms the neck passing through the lid (9) and its inside end being located inside the lid (9);
The bag (2) is mated in a rigid and airtight way to the part (21) that forms the neck toward its inside end;
At least one hole (18), made on the container (4) and/or the lid (9), can make it possible to inject a positively pressurized gas inside the barrel (1) and outside of the bag (2) so as to compress the bag (2);
Airtight sealing means (19) that can be maneuvered from the outside of the barrel (1) are able, in a selective way, to seal tightly or to open the hole (18) and, when they seal the hole (18), to maintain the positive pressure that prevails inside the barrel (1), with the sealing means (19) and the container (4) and/or the lid (9) where the hole (18) is made being equipped with complementary rigid mating means (20).

2. Barrel (1) in the assembled state and empty of liquid, according to claim 1, wherein the complementary rigid mating means (24) of the part (21) that forms the neck and the lid (9) ensure an irreversible rigid mating, with the part (21) that forms the neck and the lid (9) being mated rigidly and irreversibly.

3. Barrel (1) in the assembled state and empty of liquid, according to claim 1, wherein the complementary rigid mating means (24) of the part (21) that forms the neck and the lid (9) comprise mated surfaces that are held rigidly together by contact and forced interlocking.

4. Barrel (1) in the assembled state and empty of liquid, according to claim 1, wherein the orifice (15) of the lid (9) is limited laterally by a flange (16) that is generally cylindrical in shape, extending projecting from the terminal wall of the lid (9) toward the outside of the latter, and whose inside lateral surface (16a) of which flange (16) is equipped with means (24) for rigid mating with the part (21) that forms the neck.

5. Barrel (1) in the assembled state and empty of liquid, according to claim 1, wherein the terminal wall (12) of the lid (9) comprises a groove (17) that extends toward the inside of the lid (9).

6. Barrel (1) in the assembled state and empty of liquid, according to claim 1, wherein the part (21) that forms the neck, structurally separate from the lid (9), comprises, on the one hand, a lateral wall (22) that is generally cylindrical in shape and whose outside lateral surface (22a) is equipped with means (14) for rigid mating with the lid (9) and whose inside lateral surface (22b) is equipped with means (28) for rigid mating with the cap (25), and, on the other hand, an inside end wall in the shape of a disk (23) that just abuts against the inside surface of the terminal wall (12) of the lid (9) and to which the bag (2) is mated in a rigid and airtight way by the edge (3a) of its opening (3).

7. Barrel (1) in the assembled state and empty of liquid, according to claim 1, wherein the part (21) that forms the neck, structurally separate from the lid (9), comprises a lateral wall (22) that is generally cylindrical in shape and an inside end wall in the shape of a disk (23) with which the edge (3a) of the opening (3) of the bag (2) is mated in a rigid and airtight way by welding or gluing.

8. Barrel (1) in the assembled state and empty of liquid, according to claim 1, wherein the complementary rigid mating means (28) of the part (21) that forms the neck and the cap (25) comprise mated surfaces that are held rigidly together by contact and forced interlocking.

9. Barrel (1) in the assembled state and empty of liquid, according to claim 1, wherein the body (26) of the cap (25) is terminated by an outside end part (29a) that projects laterally and in the shape of a disk, just abutting against an outside end part (29b), projecting laterally and in the shape of a disk of the lateral wall (22) of the part (21) that forms the neck.

10. Barrel (1) in the assembled state and empty of liquid, according to claim 1, wherein the at least one hole (18) is made on the lid (9).

11. Barrel (1) in the assembled state and empty of liquid, according to claim 10, wherein the at least one hole (18) is made on the terminal wall (12) of the lid (9) in the vicinity of its orifice (15).

12. Barrel (1) in the assembled state and empty of liquid, according to claim 1, wherein the at least one hole (18) is limited by an end fitting (18a) that extends toward the outside, suitable for mounting a pipe for injection of a positively pressurized gas.

13. Barrel (1) in the assembled state and empty of liquid, according to claim 1, wherein the airtight sealing means (19) of the hole (18) are a part (19a) made of deformable plastic material, able to be deformed when it is subjected to a force that corresponds to a known pressure that is exerted on it, maneuvered for deformation of the outside of the barrel (1) in response to the injection, inside the barrel, of the positively pressurized gas through the at least one hole (18), whereby said part (19a) of the sealing means (20), on the one hand, opens the hole (18) when the positively pressurized gas is injected inside the barrel, and, on the other hand, seals the hole (18) when the injection of the positively pressurized gas inside the barrel (1) is halted or the inside of the barrel (1) is positively pressurized.

14. Barrel (1) in the assembled state and empty of liquid, according to claim 13, wherein the deformable part (19a) of the airtight sealing means (19) of the hole (18) comprises a deformable part that forms a flap that is located against the inside surface of the wall where the at least one hole (18) is located, opposite this at least one hole (18).

15. Barrel (1) in the assembled state and empty of liquid, according to claim 13, wherein the complementary rigid mating means (20) of the deformable part (19a) of the means (19) for sealing and the wall where the at least one hole (18) is located comprise at least one projection-recess unit (20a, 20b) that is rigidly held together by contact and forced interlocking.

16. Barrel (1) in the assembled state and empty of liquid, according to claim 1, wherein the complementary rigid mating means (14) of the container (4) and the lid (9) ensure an irreversible rigid mating, with the lid (9) and the container (4) being mated rigidly and irreversibly.

17. Barrel (1) in the assembled state and empty of liquid, according to claim 1, wherein the container (4), on one hand, and the lid (9) on the other hand, comprise, on the one hand, a lateral wall (5, 10) that limits its opening (6, 11), extending axially, generally cylindrical or prismatic in shape and slightly tapered toward the opening, and, on the other hand, a terminal wall (7, 12) that extends in a transverse plane.

18. Barrel (1) in the assembled state and empty of liquid, according to claim 1, wherein the container (4) and/or the lid (9) comprise(s) stiffening reliefs.

19. Barrel (1) in the assembled state and empty of liquid, according to-claim 1, wherein the container (4) and the lid (9) have an axial dimension that is analogous or of the same order of magnitude.

20. Barrel (1) in the assembled state and empty of liquid, according to claim 1, wherein the container (4), the lid (9), the bag (2) and the part (21) that forms the neck are made of plastic.

21. Barrel (1) in the assembled state and empty of liquid, according to claim 1, wherein the bag (2) has a capacity of between on the order of 5 liters to 15 liters.

22. Barrel (1) in the assembled state and empty of liquid, according to claim 1, wherein the unit that consists of the bag (2)—part (21) that forms the neck that is produced, with the bag (2) that has been attached to the part (21) that forms the neck but is not yet filled with liquid, is sealed by means of a removable stoppering system such as a removable protective cap so as to keep the bag (2) sterile until the time when it is filled with liquid.

23. Barrel (1) in the assembled state and filled with liquid, ready for use, comprising a barrel (1) in the assembled state according to claim 1, with the bag (2) being filled with a liquid such as a pressurized beverage, a positively pressurized gas that is inside the barrel (1) and outside of the bag (2) so as to compress the bag (2) that is filled with liquid.

24. Barrel (1) in the assembled state and filled with liquid, ready for use, according to claim 23, with the barrel (1) in the assembled state and empty of liquid, wherein the unit that consists of the bag (2)—part (21) that forms the neck that is produced, with the bag (2) that has been attached to the part (21) that forms the neck but is not yet filled with liquid, is sealed by means of a removable stoppering system such as a removable protective cap so as to keep the bag (2) sterile until the time when it is filled with liquid, and wherein the removable stoppering system of the unit that consists of the bag (2)—part (21) that forms the neck is removed before the bag (2) is filled with liquid.

25. Set of means to be combined in a rigid way for making up a barrel (1) according to claim 1, comprising:
An airtight and flexible bag (2), able to contain liquid and to withstand the internal or external pressure that can be exerted on it, equipped with an opening (3) through which it is possible to ensure respectively its filling with the liquid or the drafting off of the liquid that it contains;
A container (4) that can accommodate the bag (2), having a rigidity that can withstand the pressure that can exist inside the barrel, and comprising an opening (6) that is suitable for filling the bag (2); and a lid (9) in the general shape of a cap, able to close the container (4) from the side of its opening (6), having a rigidity that can withstand the pressure that may exist inside the barrel, comprising, on one side, an opening (11), and having, in a terminal wall (12) of the opposite side, an orifice (15) that can be opposite the opening of the bag (2) and in communication with it; with the container (4) and the lid (9) equipped with complementary rigid mating means (14) with sealing being able to be mated rigidly with sealing, and with their two openings (6, 11) being mated;
A part (21) that forms the neck, structurally separate from the lid (9), generally cylindrical in shape, with the outside lateral surface (22a) of the part (21) that forms the neck and the mated inside lateral surface (16a) of the orifice (15) of the lid (9) being equipped with complementary rigid mating means (24) with sealing, the part (21) that forms the neck and the lid (9) being able to be mated rigidly with sealing, the part (21) that forms the neck being able to pass through the lid (9), its inside end being able to be located inside the lid (9), with the part (21) that forms the neck being able to extend toward the outside of the lid (9) and the barrel (1) and to be located opposite the orifice (15) of the lid (9) and in communication with it, with the bag (2) being able to be mated in a rigid and airtight way to the part (21) that forms the neck toward its inside end;
A cap (25) that comprises a hollow cylindrical lateral body (26) that supports means (27a) for closing the barrel and means (27b) for drafting off liquid, with the inside lateral surface (22a) of the part (21) that forms the neck and the mated outside lateral surface (26a) of the body of the cap (25) equipped with complementary rigid mating means (28) with sealing being able to be mated rigidly with sealing;
At least one hole (18), made on the container (4) and/or the lid (9), able to make it possible to inject a positively pressurized gas inside the barrel (1) and outside of the bag (2) so as to compress the bag (2);
Airtight sealing means (19), able, in a selective way, to seal tightly or to open the hole (18), and, when they seal the hole (18), to maintain the positive pressure that prevails inside the barrel (1), with the sealing means (19) and the container (4) and/or the lid (9) where the hole (18) is made being equipped with complementary rigid mating means (20).

26. Unit according to claim 25, with the barrel (1) in the assembled state and empty of liquid, wherein the unit that consists of the bag (2)—part (21) that forms the neck that is produced, with the bag (2) that has been attached to the part (21) that forms the neck but is not yet filled with liquid, is sealed by means of a removable stoppering system such as a removable protective cap so as to keep the bag (2) sterile until the time when it is filled with liquid, and wherein it also comprises a removable stoppering system such as a removable protective cap that is designed to seal the unit that consists of the bag (2)—part (21) that forms the neck after the bag (2) has been attached to the part (21) that forms the neck but before the bag (2) is filled with liquid.

27. Process for packaging a liquid such as a pressurized beverage in a barrel (1) that is specially adapted for storing and drafting off this liquid, wherein:
The set of means according to claim 25 is used, with the bag (2) being empty of liquid, and the liquid to be packaged is used;
The bag (2) that is empty of liquid is mated in a rigid and airtight way to the part (21) that forms the neck;
The part (21) that forms the neck—to which the bag (2) is mated in a rigid way—is mated in a rigid and airtight way to the lid, with the bag (2) being placed inside the lid (9); and the bag (2) is placed inside the container (4);
Then, the container (4) and the lid (9) are mated in a rigid and airtight way;
Then, the bag (2) is filled with the liquid by the part (21) that forms the neck and the opening (3) of the bag (2);
Then, the cap (25) is mated in a rigid and airtight way to the part (21) that forms the neck.

28. Process according to claim 27, wherein once the container (4) and the lid (9) are mated in a rigid and airtight way and the bag (2) is filled with liquid, a positively pressurized gas is injected inside the barrel (1) and outside of the bag (2) so as to compress the bag (2) that is filled with liquid, with the means for sealing the hole (18) sealing the latter.

29. Process according to claim 27 with the barrel (1) in the assembled state and empty of liquid wherein once the unit that consists of the bag (2)—part (21) that forms the neck is produced—with the bag (2) having been attached to the part (21) that forms the neck but is not yet filled with liquid—this unit (2+21) is sealed by means of a removable stoppering system, so as to keep the bag (2) sterile, and wherein before the bag (2) is filled with liquid, the stoppering system is removed.
